(19) United States
(12) Patent Application Publication
(10) Pub. No.: US 2009/0311040 A1
(43) Pub. Date: Dec. 17, 2009

(54) DRIVE PLATE FOR A COUPLING DEVICE, ESPECIALLY A HYDRODYNAMIC TORQUE CONVERTER

(75) Inventors: Carsten Zuehl, Schweinfurt (DE); Michael Scordino, Canton, MI (US); Juraj Cuperka, Northville, MI (US); Bernd Reinhardt, Farmington Hills, MI (US)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/486,103

(22) Filed: Jun. 17, 2009

Related U.S. Application Data
(60) Provisional application No. 61/073,166, filed on Jun. 17, 2008.

(30) Foreign Application Priority Data
Jun. 27, 2008 (DE) 10 2008 002 711.1

(51) Int. Cl. F16D 1/033

(52) U.S. Cl. 403/337

(57) ABSTRACT

A drive plate for connecting the housing of a coupling device, especially a hydrodynamic torque converter, to a drive element such as a flexplate fixed to a drive shaft, wherein the drive plate has a substantially disk-shaped drive plate body formed from sheet metal. A first coupling formation is formed in a radially outer area of the drive plate body, the first coupling formation including a plurality of circumferentially spaced first axial elevations for connecting to a drive element. A second coupling formation is formed in a radially inner area of the drive plate body for connecting to the housing of a coupling element. A test drive formation is formed by a plurality of circumferentially spaced second axial elevations on the drive plate body, each second axial elevation having an essentially flat axially facing end surface and a pair of circumferentially facing lateral surfaces.

### RELATED APPLICATIONS

This application claims priority from U.S. Provisional Patent Application Ser. No. 61/073,166 which was filed on Jun. 17, 2008 and German Application No. 10 2008 002 711.1 which was filed on Jun. 27, 2008.

### BACKGROUND OF THE INVENTION

1. Field of the Invention

The present invention pertains to a drive plate for a coupling device such as a hydrodynamic torque converter, a wet-running multi-plate clutch, or the like. With a drive plate of this type, the housing of a coupling device of this type can be connected to a drive element such as a flexplate or the like, which is connected nonrotatably to a drive shaft.

2. Description of the Related Art

After they have been assembled, coupling devices which serve in the drive train of a vehicle to transmit torque between a drive unit and a following part of the drive train such as a gearbox are subjected to function tests on test benches. So that torque can be introduced into the coupling device such as a converter housing, for example, during these function tests, it is known that several projections can be welded onto the converter housing to act as contact surfaces for the torque test drive. Adding these welded-on projections to the outside surface of the housing suffers from the disadvantage that an extra work step is required, but the problem is also created that deformations can be produced in the housing by the welding operation. This is especially problematic when a friction surface for a bridging clutch is formed on the inner side of the housing, because the welding operation can cause waviness in this surface and thus impair its quality.

### SUMMARY OF THE INVENTION

An object of the present invention is to provide a drive plate for a hydrodynamic coupling device, especially a torque converter, by means of which the housing of the coupling device can be connected to a drive element, and which also makes it possible to conduct function tests.

According to the invention, the drive plate has a drive plate body designed as a formed metal part with a radially outer first coupling formation for connecting the drive plate to a drive element, where the first coupling formation includes a plurality of first axial elevations on the drive plate body arranged a certain distance apart in a circumferential row around an axis of rotation; a radially inner second coupling formation for connecting the drive plate to the housing of a coupling device; and a test drive coupling formation, including a plurality of second axial elevations arranged a certain distance apart in the circumferential direction, each of these having an essentially flat, axially-facing end surface area and two lateral surface areas facing more-or-less in the circumferential direction.

In addition to the coupling formations provided for connecting the drive plate to the housing on one side and to a drive element on the other side, the inventively designed drive plate in the form of a formed metal part produced from, for example, a sheet metal blank, also has a test drive coupling formation, by means of which a test drive on a test bench can exert force on the drive plate and thus on the coupling device connected to it. There is therefore no longer any need to provide additional elements on the housing of the coupling device to allow torque to be introduced during the function test, and thus it will also be impossible for any deformation problems to occur in the area of the coupling device.

So that a stable torque-transmitting connection can be established on the test bench, the second axial elevations are preferably formed as bridge-like elevations on the drive plate body and are connected in their radially outer and radially inner areas to the drive plate body.

It is preferably also provided that the lateral surface areas of the second axial elevations are essentially parallel to each other.

A defined introduction of torque on a test bench can be further facilitated in that the lateral surface areas of the second axial elevations are essentially at right angles to the end surface areas of the elevation.

A configuration of this type can be reliably achieved in the case of a formed metal component by separating the lateral surface areas from the drive plate body by through-cuts.

To avoid damage in the area of the drive plate during the introduction of torque by way of the test drive coupling formation, the through-cuts terminate in stress-relief openings in the radially outer and radially inner areas of the second axial elevations.

It can be ensured that the torque is introduced uniformly around the circumference during the performance of function tests by locating each second axial elevation between two first axial elevations. For example, only one second axial elevation can be provided between two first axial elevations, and the number of second axial elevations can be smaller than the number of first axial elevations.

In the case of the inventive drive plate, the second axial elevations of the test drive coupling formation remain on the drive plate after completion of the function tests. To ensure that these second axial elevations do not cause any interference during normal torque-transmitting operation in a drive train, the projecting height of the second axial elevations is coordinated with the projecting height of the first axial elevations and/or the drive element in such a way that, after the drive plate has been connected to the drive element, the second axial elevations do not come in contact with the drive element.

The first axial elevations can be open in the radially outward direction, and the first coupling formation may also include a threaded connecting element for each of the first axial elevations, these connecting elements being fixed in position on the drive plate or produced as an integral part of the plate by metal-forming, for example, and/or by machining.

The second coupling formation can have a plurality of through holes, through which, for example, rivet pins or the like produced as integral parts of the housing of the coupling device can be passed to connect the drive plate permanently to the housing, the ends of the rivet pins being deformed to grip the drive plate from behind.

The present invention also pertains to a coupling device, especially a hydrodynamic torque converter, with a housing and an inventively designed drive plate attached to the housing.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a perspective view of an inventively designed drive plate;

FIG. 2 shows an axial view of a drive plate;

FIG. 3 shows a partial cross-sectional view of the drive plate according to FIG. 2 along line III-III in FIG. 2;

FIG. 4 shows a partial cross-sectional view of the drive disk of FIG. 2 along line IV-IV of FIG. 2;

FIG. 5 shows a cross-sectional view of the drive disk shown in FIG. 2 along line V-V in FIG. 2; and

FIG. 6 shows the drive disk fixed to the housing of a torque converter, and a flex plate fixed to a driveshaft.

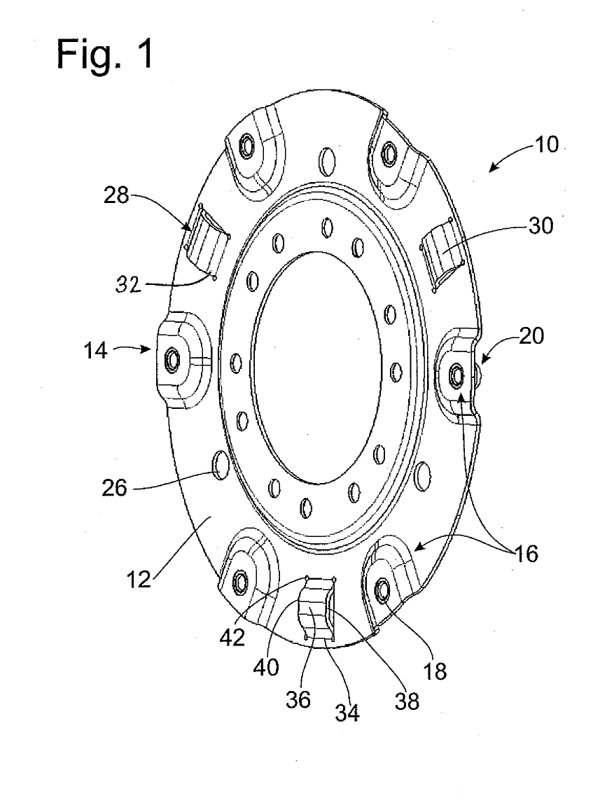

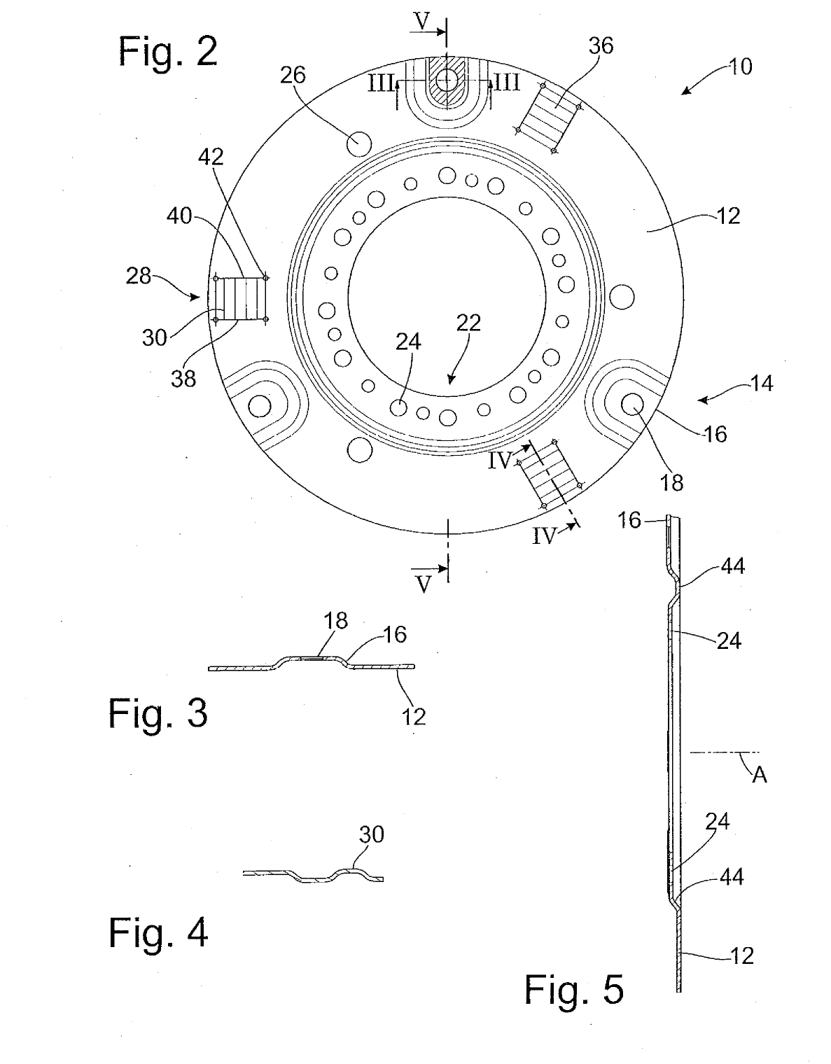

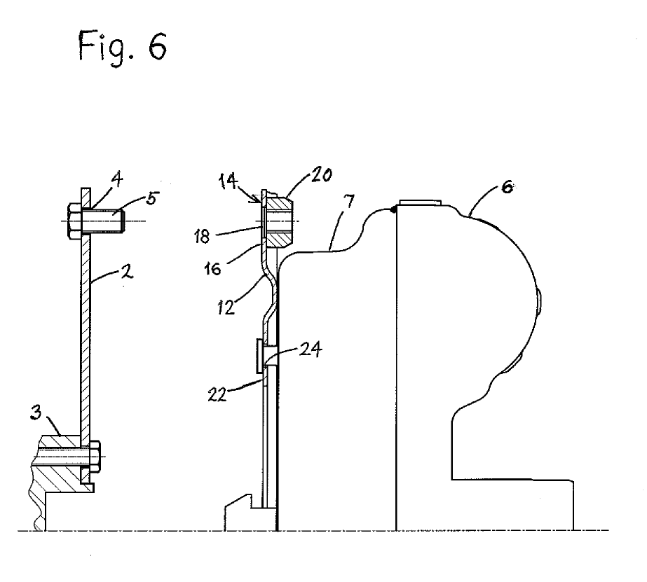

### DETAILED DESCRIPTION OF THE PRESENTLY PREFERRED EMBODIMENTS

In the figures, a drive plate is designated in general by the number 10. This drive plate 10 is produced from a stamped sheet metal blank by a metal-forming process. The drive plate 10 has a drive plate body 12, the radially outer part of which has a first coupling formation 14, consisting of a plurality of first axial elevations 16, preferably arranged equal distances apart in the circumferential direction. The first axial elevations 16 are open radially toward the outside, and each has a hole 18. These holes can be provided with a thread, or a threaded element 20 can be attached to the drive plate body 12. The first coupling formation 14 is used to establish a nonrotatable connection between the drive plate 10 and a drive element such as a flexplate 2, which is held in place on the drive shaft 3 of a drive unit such as the crankshaft of an internal combustion engine. The fixed connection between the drive plate 10 and a flexplate 2 or the like can be realized by means of bolts 5, which are passed through holes 4 in the flexplate and screwed into the threaded elements 20.

The fixed attachment of the drive plate 10 to the housing of a coupling device, i.e., to the housing 7 of a hydrodynamic torque converter 6, for example, is accomplished in the radially inner area of the ring-like drive plate body 12. There, a second coupling formation 22 with a plurality of through holes 24 distributed around the circumference is provided Rivet pins formed as integral parts of the housing or separate rivet elements or bolts, for example, can be passed through these holes 24 to establish a fixed connection between the housing and the drive plate body 12.

So that standardized tools can grip the drive plate 10 during the fabrication process, that is, so that several different types of drive plates can be handled with the same tools, auxiliary holes 26 are provided in the drive plate 10, three in the example shown here. These holes 26 are distributed uniformly around the circumference and located in the radially middle area of the drive plate body 12. Each one is positioned, for example, in the circumferential direction between two first axial elevations 16.

The drive plate 10 also has a test drive coupling formation 28 on the drive plate body 12, formed as an integral part of that body. In the example shown here, this formation includes three second axial elevations 30. These second axial elevations 30 are located more-or-less on the same radial level as the first axial elevations 16 and are preferably positioned in the circumferential direction between two first axial elevations 16. An uncentered positioning of the second axial elevations 30 can also be selected. It can be seen that the second axial elevations 30 are positioned in the areas between two first axial elevations 16 which do not already have an auxiliary opening 26.

The second axial elevations 30 are designed essentially in the form of bridges; that is, their radially inner areas 32 and their radially outer areas 34 are connected to the rest of the drive plate body 12. In between their two ends, the second axial elevations 30 project above the area of the drive plate body 12 surrounding them, and between their radially inner areas 32 and their radially outer areas 34 they form essentially flat end surface areas 36, which face in the axial direction, that is in a direction parallel to the axis of rotation. On both circumferential sides, the second axial elevations 30 have lateral flank areas 38, 40. These two lateral flank areas 38, 40 are essentially parallel to each other, “essentially” meaning that they could also be arranged at a small angle to each other, and they are essentially at right angles to the end surface area 36. The lateral flank areas 38, 40 can be formed by introducing through-cuts extending more-or-less radially but parallel to each other in the drive plate body 12 before the forming operation employed to produce the second axial elevations 30. The surfaces of the through-cuts thus made then form the lateral flank areas 38, 40 of the second axial elevations 30. So that stress can be decreased under load and so that a uniform stress distribution can be obtained at the ends of these through-cuts, they terminate radially on the inside and radially on the outside in stress-relief openings 42. These stress-relief openings 42 are therefore located on the same radial levels as the radially inner terminal area 32 and the radially outer terminal area 34 of the associated second axial elevation.

After the plate has been fixed in place on the housing of a coupling device, i.e., on the housing of, for example, a hydrodynamic torque converter, and after the torque converter itself has been assembled, the inventive drive plate 10 makes it possible to transmit a torque to the drive plate 10 and thus to the housing of the coupling device on a test bench. For this purpose, the test bench has contact areas corresponding to the second axial elevations 30; these contact areas can come in contact with the axially-facing end surface areas 36 and also contact either of the circumferentially facing lateral flank areas 38, 40. It is then possible for torque to be transmitted via the drive plate 10 to the housing to perform the function test. No additional measures need to be taken on the housing of the coupling device itself for this purpose. In particular, the inventive design of a drive plate 10 makes it easy to lay out the test drive coupling formation 28 with its second axial elevations 30 in such a way that it can cooperate with the test bench intended for the performance of the function test, the bench being provided with, for example, standardized contact areas for the transmission of the torque. It is therefore possible with one and the same test bench to perform function tests on a wide variety of coupling devices, the drive plates of which are themselves designed with, for example, a standardized test drive coupling formation with second axial elevations.

Because the test drive coupling formation is provided on the drive plate itself, it is possible to eliminate additional machining operations in the area of the housing of the coupling device, so that there is also no danger of producing deformations, especially in the area of a friction surface of a bridging clutch.

It also becomes possible to build the drive plate and the housing out of materials optimized for the specific requirements in question.

After a function test has been performed, the coupling device together with the drive plate 10 already attached to it can be integrated into a drive train, for example, by connecting the radially outer area of a flexplate to the first coupling formation 16 in the previously described manner. Because the test drive coupling formation 28 remains on the drive plate 10 even after the completion of the function test, the second axial elevations 30 are dimensioned so that they cannot come in contact with the flexplate or any other drive element which may be connected to the drive plate 10. For this purpose, the end surface areas 36 of the second axial elevations 30 can be set back axially from the contact surfaces formed in the area of the first axial elevations 16 in the direction away from the coupling element. This can be done, for example, by making the degree to which the second axial elevations 30 project axially beyond the disk-like area of the drive plate smaller than the degree to which the first axial elevations 16 project.

To increase the stability of the drive plate 10, the radially middle area of the plate, that is, the area located radially essentially between the first axial elevations 16 and through holes 24, has a ring-like circumferential elevation or an offset 44. As can be seen in FIG. 5, the drive plate body 12 can basically lie on different axial levels, namely, on one level radially inside this offset 44 and on another level radially outside this offset 44. The first and second axial elevations 16 and 30 project from the level radially outside the offset 44.

It should be pointed out in conclusion that, especially in the area of the various axial elevations 16, 30, the drive plate 10 can be designed with a wide variety of different configurations, especially with respect to the number of elevations. For example, the first axial elevations 16 could be designed in the form of bridges like the second axial elevations 30 and be separated from the drive plate body 12 at both circumferential ends by through-cuts or openings in the drive plate body 12. The first axial elevations 16 can also be designed to extend radially outward beyond the ring-like area of the drive plate body 16, which would be taken into account by selecting an appropriate shape for the blank, produced by stamping, for example, used to fabricate the drive plate body 12.

The invention is not limited by the embodiments described above which are presented as examples only but can be modified in various ways within the scope of protection defined by the appended patent claims.

I claim:

1. A drive plate for connecting the housing of a coupling device to a drive element, wherein the drive plate comprises a substantially disk-shaped drive plate body having a radially outer area and a radially inner area, the plate body being formed from sheet metal and comprising:
a first coupling formation in the radially outer area, the first coupling formation comprising a plurality of circumferentially spaced first axial elevations for connecting to a drive element;
a second coupling formation in the radially inner area for connecting to the housing of a coupling device; and
a test drive formation comprising a plurality of circumferentially spaced second axial elevations in the radially outer area, each said second axial elevation comprising an essentially flat axially facing end surface and a pair of circumferentially facing lateral surfaces.

2. The drive plate of claim 1 wherein each said second axial elevation is formed as a bridge having a radially outer end and a radially inner end connected to the drive plate body.

3. The drive plate of claim 1 wherein the lateral surfaces of each said second axial elevation are essentially parallel.

4. The drive plate of claim 1 wherein the lateral surfaces of each said second axial elevation are at right angles to the respective said end surface.

5. The drive plate of claim 2 wherein the lateral surfaces are separated from the drive plate body by through cuts.

6. The drive plate of claim 5 further comprising stress-relief openings at opposite ends of each said through cut.

7. The drive plate of claim 1 wherein each said second axial elevation is located circumferentially between two said first axial elevations.

8. The drive plate of claim 7 wherein only one said second axial elevation is located between two said first axial elevations.

9. The drive plate of claim 1 wherein there are fewer second axial elevations than first axial elevations.

10. The drive plate of claim 1 wherein the axial elevations are configured so that the second axial elevations do not contact the drive element, when the first elevations are connected to the drive element.

11. The drive plate of claim 1, wherein the first axial elevations are open in a radially-outward facing direction.

12. The drive plate of claim 1 wherein the first coupling formation comprises a threaded connecting element on each of said first axial elevations.

13. The drive plate of claim 1 wherein the second coupling formation comprises a plurality of through holes.
